(19) United States
(12) Patent Application Publication
(10) Pub. No.: US 2026/0170662 A1
(43) Pub. Date: Jun. 18, 2026

(54) ACTIVE MACHINE LEARNING FOR MOBILE OBJECT CONTROL

(71) Applicant: Ford Global Technologies, LLC, Dearborn, MI (US)

(72) Inventors: Yutong Li, Novi, MI (US); Shruthi Venkat, San Jose, CA (US); Sandhya Sridhar, Cupertino, CA (US); Michael Feller, Farmington Hills, MI (US); Lars Kuhnert, Köln/NRW (DE)

(73) Assignee: Ford Global Technologies, LLC, Dearborn, MI (US)

(21) Appl. No.: 18/978,012

(22) Filed: Dec. 12, 2024

(51) Int. Cl. G06T 7/20; G06T 7/50; G06V 10/44; G06V 20/70

(52) U.S. Cl. CPC G06T 7/20; G06T 7/50; G06V 10/44; G06V 20/70; G06T 2207/20081; G06T 2207/30241; G06T 2207/30252

(57) ABSTRACT

A computer can include a processor and a memory. The memory can include instructions executable by the processor to determine a depth map based on an image received by a machine learning model trained on a first training dataset. The computer can determine an object trajectory for an object included in the image. The image can be selected based on determining an interference between the object and the depth map based on the object trajectory. A second training dataset can be determined by adding the selected image to the first training dataset. The machine learning model can be trained with the second training dataset.

### BACKGROUND

Computers can operate systems and devices including vehicles, robots, drones, and/or object tracking systems. Data including images can be acquired by sensors and processed by a computer to determine a trajectory for a system with respect to an environment and with respect to objects in the environment. A computer may use the trajectory to operate the system or operate components thereof in the environment.

### BRIEF DESCRIPTION OF THE DRAWINGS

FIG. 1 is a block diagram of an example image-based system.

FIG. 2 is a diagram of an example vehicle with sensors.

FIG. 3 is a diagram of an example fisheye images.

FIG. 4 is a diagram of an example bird's eye view image.

FIG. 5 is a diagram of an example machine learning model.

FIG. 6 is a diagram of an example bird's eye view image with an overlaid grid.

FIG. 7 is a diagram of an example bird's eye view image with an overlaid grid and occupied cells.

FIG. 8 is a diagram of an example image with occupied cells and a vehicle trajectory.

FIG. 9 is a diagram of another example image with occupied cells and a vehicle trajectory.

FIG. 10 is a diagram of example vehicle outlines.

FIG. 11 is a diagram of another example image illustrating cells occupied by a vehicle.

FIG. 12 is a diagram of an example system for active machine learning.

FIG. 13 is a flowchart diagram of a process for active machine learning.

FIG. 14 is a flowchart diagram of a process to operate a vehicle based on training a machine learning model with active learning.

### DETAILED DESCRIPTION

Systems that move and/or that have mobile components, including vehicles, robots, drones, cell phones etc., can be operated by acquiring sensor data, including data regarding an environment around the system, and processing the sensor data to determine identities and locations of objects in an environment around a system. The determined identity and location data could be processed to determine operation of the system or portions of the system. For example, a robot could determine the location of another nearby robot's arm. The determined robot arm location could be used by the robot to determine a path upon which to move a gripper to grasp a workpiece without encountering the other robot's arm. In another example, a vehicle could determine its location with respect to an environment around the vehicle and locations of objects such as a roadway and other vehicles in the environment. The vehicle could use its determined location and the determined identities and locations of the objects to determine a path upon which to operate while maintaining a predetermined relationship to the objects. Vehicle operation will be used herein as a non-limiting example of object identity and location determination in the description below.

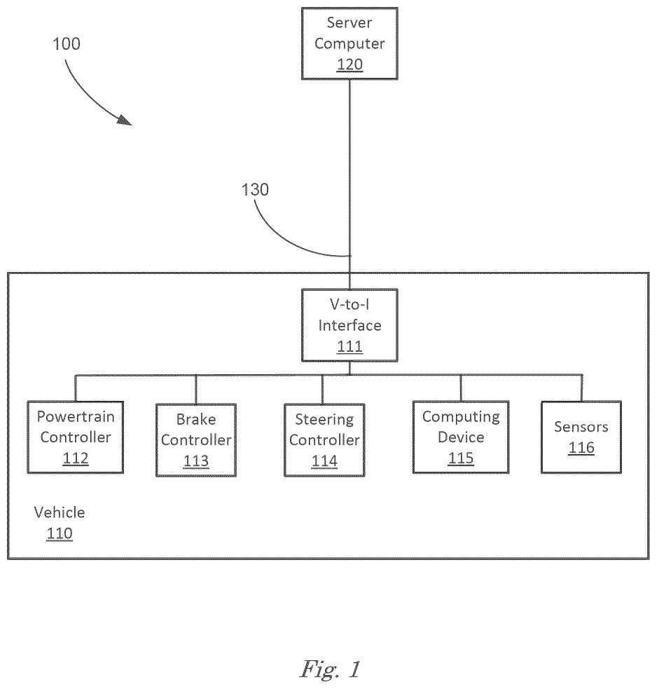

A machine learning model can be trained on a server computer and then installed in a computing device in a vehicle to receive sensor data from sensors included in the vehicle. The machine learning model can determine predictions regarding the received sensor data to assist in operating the vehicle. For example, a machine learning model can be trained to receive images from a video camera and determine locations for objects in an environment around the vehicle. A predicted state output from the machine learning model can include predicting a location and orientation of an object with respect to the vehicle including a distance and an angle between the vehicle and the object. The object prediction data can be used by a computing device included in the vehicle to determine a trajectory that the vehicle could travel on to reach a predicted future location. The computing device can then control the vehicle to travel on the trajectory by issuing commands to controllers which operate vehicle components such as propulsion, steering, and brakes as described below in relation to FIG. 1.

The performance of a machine learning model can be determined by comparing the identities and locations assigned to objects such as vehicles, roadways, curbs, buildings, trees, traffic signs, traffic barriers, etc., occurring in input images with ground truth data (or simply “ground truth”). Ground truth includes object identities and locations obtained from a source other than the machine learning model being tested. Examples of sources for ground truth include other, previously trained machine learning models or humans. Performance of a machine learning model can be measured by determining the percentage of objects correctly identified and located within a user determined threshold as compared to identities and locations included in ground truth data.

The performance of a machine learning model can depend upon images in the training dataset accurately representing the types of images to be encountered when the machine learning model is deployed to the field. A brute force approach to determining a representative training dataset can be to simply acquire a very large number of images, determine ground truth for all of them, and use the entire training dataset for training and testing the machine learning model. Determining ground truth, also referred to herein as labeling, includes determining identities and locations of objects in an image. The process of determining ground truth data and training a machine learning model requires computing resources for machine learning labeling directly proportional to the number images in the training dataset. Techniques described herein use active learning techniques to train high performance machine learning models while minimizing the number of images required in the training dataset.

Active learning is a technique for identifying input data that enhances the performance of a machine learning model when used to train the machine learning model before computing resources are expended in determining ground truth and training the machine learning model with additional data. Active learning samples data from an unlabeled dataset to select data based on results to label and subsequently train the machine learning model. The machine learning model is first trained using a labeled training dataset that includes a subset of the available data. Unlabeled data is then selected from the remaining data to be processed by the machine learning model. Results from the unlabeled data are evaluated to determine if the data should be labeled and added to the training set. Data that produces inaccurate results are selected for labeling and further training based on the assumption that further training based on inaccurate results will provide the greatest gain in performance of the machine learning model.

Several different schemes exist for determining the accuracy of results for active learning. Some schemes rely on confidence values output by the machine learning model to measure uncertainty in the result or to determine a margin of confidence based on comparing likely results output from the machine learning model. Other techniques measure the entropy, or average amount of information output from a machine learning model. Other techniques rely on training multiple machine learning models using different training datasets and comparing the results between the different systems. All of these techniques rely on specially coded machine learning models that output confidence values or entropy values and require computing resources in addition to the machine learning model. Techniques described herein for active learning do not rely on confidence values or entropy values and do not require additional computer resources to determine these values. Techniques described herein for active learning can be applied to classification tasks, such as identifying an object, and regression tasks such as locating an object.

Techniques described herein for active machine learning use available vehicle data to test the accuracy of predictions output by a machine learning model by determining a one-dimensional feature such as contact between a moving object and objects in the environment. If the available vehicle data indicates that the predictions regarding object identities and locations is inaccurate, the image data used to generate the predictions can be labeled to generate ground truth and the selected images and corresponding ground truth data can be included in a training dataset to be used for further training of the machine learning model. By selecting image data that generates erroneous identity and/or location predictions, techniques described herein can enhance training of a machine learning model by increasing performance while minimizing computing resources used to label images and train the machine learning model.

Techniques described herein for active machine learning include acquiring image data from vehicles along with sensor data that describes the vehicle pose, which includes vehicle location and orientation, for multiple time steps following in the acquisition of the image data. Feature activation data can also be acquired from vehicles. Feature activation means that a vehicle feature, such as contact, airbag deployment, computer controlled stopping and/or steering, etc., is activated, that is, commanded by a vehicle computing device in reaction to an object in the vehicle's environment. Feature activation can be indicated by computer data that is stored to log or record the feature activation. Feature activation can occur in reaction to an interference or to prevent an interference, where interference here means contact with an object in an environment around a vehicle. Possible interference can also be detected by abrupt changes in a vehicle's trajectory that may or may not be accompanied by an activation event.

Active machine learning as disclosed herein can select data for labeling and training based on examining image data output from the machine learning system and comparing it to vehicle trajectory data and feature activation data. If the image data output from the machine learning system combined with the vehicle trajectory data indicates that an interference might have occurred, but the vehicle trajectory data and/or feature activation data indicates that possible contact between the vehicle and an object was likely not present, labeling training data and training the machine learning system enhance the performance of the machine learning system. Likewise, if the combination of image data output from the machine learning system and vehicle trajectory data indicates that no interference occurred, but the vehicle trajectory and/or feature activation data indicates that an interference did in fact occur, labeling and training the machine learning system will enhance the performance of the machine learning system.

A method is disclosed herein including determining a depth map based on an image received by a machine learning model trained on a first dataset and determining an object trajectory for an object included in the image. The image can be selected based on determining an interference between the object and the depth map based on the object trajectory. A second training dataset can be determined by adding the selected image to the first training dataset. The machine learning model can be trained with the second training dataset. The machine learning model can determine locations of three-dimensional features in a depth map of an environment around the object. The depth map can be formatted as laid out on a grid, wherein one or more of the cells are occupied cells, that are occupied by one or more of the three-dimensional features with a height that exceeds a user-determined threshold with respect to a ground plane. The interference can be determined by an overlap between the object and the one or more occupied cells at a location predicted based on the trajectory.

The trajectory of the object can be determined based on sensor data from sensors included in the object. Adding the selected images to the first training dataset can include determining a label for the object. A second machine learning model can determine the label for the object. The machine learning model can be a generative adversarial network that includes an encoder, a decoder, and a discriminator. The depth map can include portions of one or more of a roadway, a curb, a building, and a tree. The object can be a vehicle. A second computer can be included, wherein the machine learning model after training is included in the second computer in a second vehicle, wherein the second computer is programmed to operate the second vehicle by determining a vehicle trajectory based on output from the machine learning model, the second computer can be programmed to operate the second vehicle on the vehicle trajectory by commanding controllers to operate vehicle components. Adding the selected images to the first training dataset can include determining a location for the object. A second machine learning model can determine the location for the object.

Further disclosed is a computer readable medium, storing program instructions for executing some or all of the above method steps. Further disclosed is a computer programmed for executing some or all of the above method steps, including a computer apparatus, programmed to determine a depth map based on an image received by a machine learning model trained on a first dataset and determine an object trajectory for an object included in the image. The image can be selected based on determining an interference between the object and the depth map based on the object trajectory. A second training dataset can be determined by adding the selected image to the first training dataset. The machine learning model can be trained with the second training dataset. The machine learning model can determine locations of three-dimensional features in a depth map of an environment around the object. The depth map can be formatted as laid out on a grid, wherein one or more of the cells are occupied cells, that are occupied by one or more of the three-dimensional features with a height that exceeds a user-determined threshold with respect to a ground plane. The interference can be determined by an overlap between the object and the one or more occupied cells at a location predicted based on the trajectory.

The instructions can include further instructions to determine a trajectory of the object based on sensor data from sensors included in the object. Adding the selected images to the first training dataset can include determining a label for the object. A second machine learning model can determine the label for the object. The machine learning model can be a generative adversarial network that includes an encoder, a decoder, and a discriminator. The depth map can include portions of one or more of a roadway, a curb, a building, and a tree. The object can be a vehicle. A second computer can be included, wherein the machine learning model after training is included in the second computer in a second vehicle, wherein the second computer is programmed to operate the second vehicle by determining a vehicle trajectory based on output from the machine learning model, the second computer can be programmed to operate the second vehicle on the vehicle trajectory by commanding controllers to operate vehicle components. Adding the selected images to the first training dataset can include determining a location for the object. A second machine learning model can determine the location for the object.

FIG. 1 is a diagram of an imaged based system 100. In this example, system 100 includes a vehicle 110, however, in other examples system 100 could include other devices that move and/or have movable components, such as a robot, a drone, or an object tracking device. In examples where system 100 includes a robot, a drone, or an object tracking device, controllers 112, 113, 114 would be controllers that control robot, drone, or object tracking device components. In examples described herein, system 100 includes a vehicle 110, a computing device 115 included in the vehicle 110, and a server computer 120 remote from the vehicle 110. One or more vehicle 110 computing devices 115 can receive data regarding the operation of the vehicle 110 from sensors 116. The computing device 115 may operate vehicle 110 based on data received from the sensors 116 and data received from the remote server computer 120. The server computer 120 can communicate with the vehicle 110 via a network 130.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of speed in the vehicle 110 by controlling one or more of an internal combustion engine, electric motor, hybrid engine, etc.), steering, climate control, interior and exterior lights, etc., as well as to determine whether and when the computing device 115, as opposed to a human operator, is to control such operations. The computing device 115 can also control the temporal alignment of lighting to sensor acquisition to account for the color effects of vehicle lights or external lights (i.e., lighting can be adjusted to facilitate collection of image data by sensors 116, the adjustments occurring at times determined for sensor 116 data acquisition).

The computing device 115 may include or be communicatively coupled to, i.e., via a vehicle communications bus as described further below, more than one computing devices, i.e., controllers or the like included in the vehicle 110 for monitoring and controlling various vehicle components, i.e., a propulsion controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in vehicle 110 and receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2I) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and wireless networking technologies, i.e., cellular, BLUETOOTH®, Bluetooth Low Energy (BLE), Ultra-Wideband (UWB), Peer-to-Peer communication, UWB based Radar, IEEE 802.11, and other wired and wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2I) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and control various vehicle 110 components and operations. For example, the computing device 115 may include programming to control vehicle 110 operational behaviors (i.e., physical manifestations of vehicle 110 operation) such as speed, steering, etc., as well as tactical behaviors (i.e., control of operational behaviors typically in a manner intended to achieve efficient traversal of a route) such as a distance between vehicles and amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and control a specific vehicle subsystem. Examples include a propulsion controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110, like the computing device 115, include a computer processor, and may include electronic control units (ECUs) or the like including, as non-limiting examples, one or more propulsion controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices such as are known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and other sensors 116 and the geographical coordinates provided by the GPS sensor may be used by the computing device 115 to operate the vehicle 110 autonomously or semi-autonomously, for example.

The vehicle 110 is generally a land-based vehicle 110 and may be capable of autonomous and/or semi-autonomous operation and typically has three or more wheels, i.e., a passenger car, light truck, etc. Vehicle 110 includes one or more sensors 116, the V2I interface 111, the computing device 115 and one or more controllers 112, 113, 114. Sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, power applied to controllers 112, 113, 114 in the vehicle 110, connectivity between components, and accurate and timely performance of components of the vehicle 110.

Server computer 120 typically has features in common (e.g., a computer processor and memory and configuration for communication via a network 130) with the vehicle 110 V2I interface 111 and computing device 115, and therefore these features will not be described further to reduce redundancy. A server computer 120 can be used to develop and train machine learning models that can be transmitted to a computing device 115 in a vehicle 110.

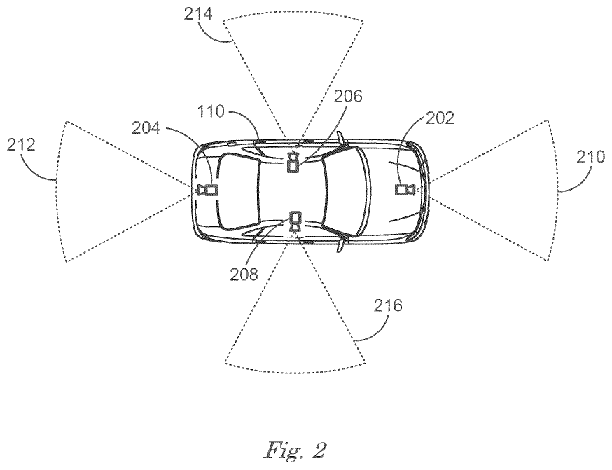

FIG. 2 is a diagram of an example vehicle 110 that includes front camera 202, rear camera 204 and side cameras 206, 208. Front, rear and side cameras 202, 204, 206, 208 include fields of view 210, 212, 214, 216, respectively. Front, rear and side cameras 202, 204, 206, 208 can be fisheye cameras that permit field of view 210, 212, 214, 216 to acquire image data that provides a 360 degree view of an environment around vehicle 110. A fisheye camera includes an ultra wide-angle (fisheye) lens that acquires images having an extremely wide field of view. Fisheye cameras are included in vehicle 110 because they can acquire image data from a field of view that would require two or more cameras having rectilinear lenses to cover.

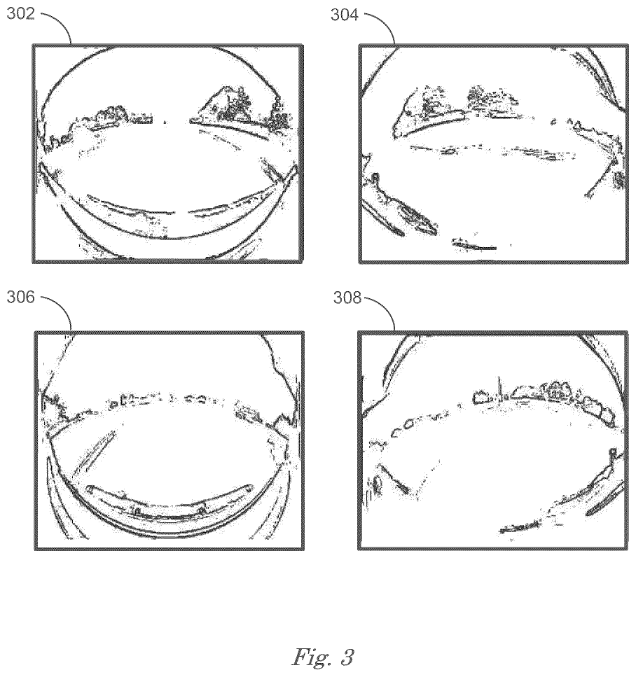

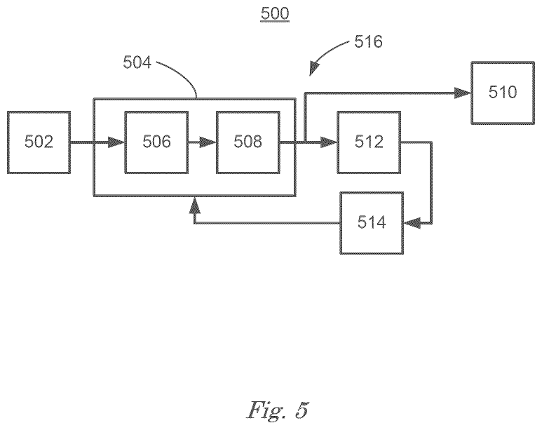

FIG. 3 is a diagram of four fisheye images 302, 304, 306, 308 acquired by cameras 202, 204, 206, 208, respectively. Despite their advantage in covering a large field of view, fisheye images 302, 304, 306, 308 have the disadvantage of distorting objects in the field of view. Convex distortion included in the fisheye images 302, 304, 306, 308 can cause lines that are straight in the real world to appear curved in the fisheye images 302, 304, 306, 308. Furthermore, object distortion differs depending upon where the object is in the field of view, making identifying and locating objects with a machine learning model difficult. In some examples fisheye images 302, 304, 306, 308 can be transformed into a rectilinear bird's eye view (BEV) image using fisheye-to-rectilinear transformations and image stitching. In techniques described herein the fisheye-to-rectilinear transformations and image stitching which transform fisheye images 302, 304, 306, 308 into a BEV image are performed by a machine learning model as described below in relation to FIG. 5.

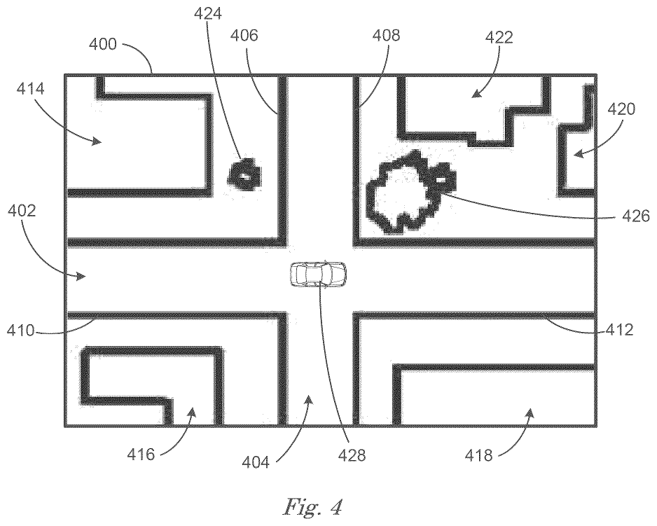

FIG. 4 is a diagram of a BEV image 400 formed by transforming fisheye images 302, 304, 306, 308 into a single BEV image 400 by inputting the images 302, 304, 306 into a machine learning model. BEV mages appear as if they were acquired from a camera with a normal, non-distorting lens from a position looking straight down on a scene.

BEV image 400 can also be referred to as a depth map because BEV image 400 includes heights of objects included in the BEV image 400. Object height can be determined by a machine learning model based on locations of the pixels corresponding to the top edge of vertical surfaces included in the objects. Once the model determines a ground plane based on identifying roadway 402, 404 pixels, heights of objects such as curbs 406, 408, 410, 412, buildings 414, 416, 418, 420, 422, and trees 424, 426 can be determined by assuming that they extend vertically from the ground plane.

The BEV image 400 includes roadways 402, 404 bordered by curbs 406, 408, 410, 412. Buildings 414, 416, 418, 420, 422 are included in the BEV image 400, along with trees 424, 426. The BEV image 400 also includes an icon 428 that denotes the location of vehicle 110 that included the cameras 202, 204, 206, 208 that acquired the fisheye images 302, 304, 306, 308 that were transformed and stitched together to form BEV image 400. The transformation that generates the BEV image 400 can include height data for objects including roadways 402, 404, curbs 406, 408, 410, 412, buildings 414, 416, 418, 420, 422, and trees 424, 426. The height assigned to roadways 402, 404 can be regarded as a ground plane and heights of other objects in the BEV image 400 can be indicated with respect to the ground plane. Heights can be indicated in global coordinates (i.e., X and Y or longitude and latitude geo-coordinates, or a Cartesian coordinate system with respect to a vehicle) and centimeters above the ground plane, for example.

Techniques described herein can use a machine learning model to generate the BEV image 400 from fisheye images 302, 304, 306, 308 Generating the BEV image 400 can reduce the computing resources required to generate the BEV image 400 compared to mathematically generating the BEV image 400. Additionally, training the machine learning model using adaptive learning can reduce the computing resources required to generate the training dataset and train the machine learning model.

FIG. 5 is a diagram of a machine learning model 500 that includes a generative adversarial network (GAN) 516. A GAN 516 is an example machine learning model 500 that can be used to generate BEV image 510 from input fisheye images 502. A GAN 516 includes a generator network 504 which includes decoder 506 and encoder 508 layers followed by a discriminator network 512. Decoder 506 and encoder 508 input image data and process it by convolving it with kernels whose weights are determined by training the decoder 506 and encoder 508. Discriminator 512 is trained using ground truth BEV images 400 to determine whether an output BEV image 510 is “real” or “fake” based on determining whether the output BEV image 510 is similar in appearance to a ground truth BEV image. At training time output BEV images 510 from the generator network 504 are passed to a trained discriminator network 512 which receives the output image 510 and determines whether the output image 510 from the generator network 504 is real or fake.

At training time, the output from the discriminator (e.g. “real” or “fake”) along with the output image 510 forms a loss function 514 which is back propagated to the generator network 504 for training the generator network 504. A GAN 516 is regarded as trained when the discriminator network 512 accepts output images 510 generated by the generator network 504 as real BEV images 400. At inference time the output image 510 from the generator network 504 is used as the output results and the discriminator is not used. An overview of techniques for using a GAN 516 to convert fisheye images to rectilinear images is “A Comprehensive Overview of Fisheye Camera Distortion Correction Methods,” Jian Xu, De-Wei Han, Kang Li Jun-Jie Li, and Zhao-Yuan Ma, May 2024, available at https://arxiv.org/abs/2401.00442 as of the filing date of this application

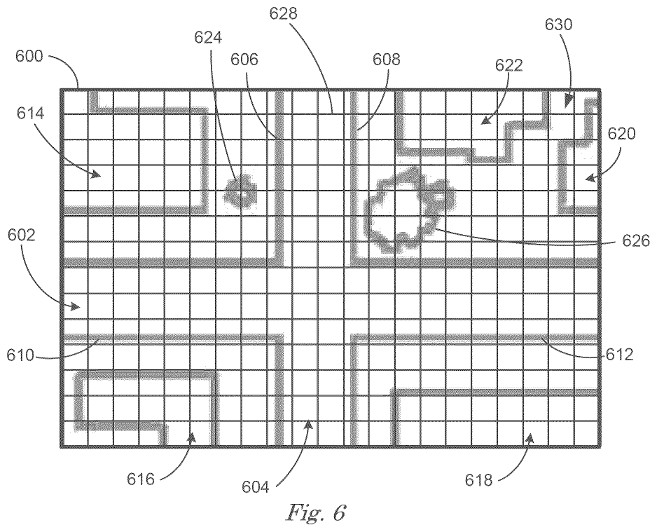

FIG. 6 is a diagram of a BEV image 600 formatted as cells laid out on grid 628. BEV image 600 is generated by a machine learning model 500 in response to input fisheye images 302, 304, 306, 308 as discussed above in relation to FIGS. 3-5. Processing by machine learning model 500 as described above in relation to FIGS. 3-5 generates a BEV image 600 that includes height data regarding objects 630 in BEV image 600. Objects 630 in BEV image 600 include roadways 602, 604, curbs 606, 608, 610, 612, buildings 614, 616, 618, 620, 622 and trees 624, 626. The height of objects 630 included in BEV image 600 can be in global coordinates, for example meters. Global coordinates are based on latitude, longitude, and altitude. Roadways 602, 604 can be assumed to be a local ground plane and the heights of all other objects 630 in BEV image 600 can be measured with respect to the ground plane.

Each cell of grid 628 can include one number that indicates the height of the portion of BEV image 600 that the cells enclose. The height of the cell can be determined by determining a height of three-dimensional features based on pixels included in BEV image 600 occurring within grid 628 cell. Determining heights of grid 628 cells in this fashion permits calculations to be performed on BEV image 600 at much lower resolution than the pixel resolution of BEV image 600 while retaining object 630 height and location data at useful resolutions. Performing calculations on BEV image 600 at grid 628 resolutions enhances techniques for adaptive learning by reducing the computing resources required to determine interference between vehicle trajectories and object 630 locations and heights.

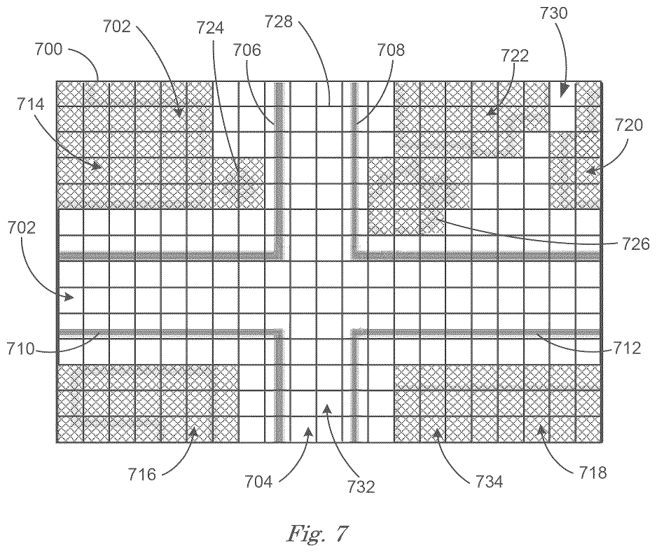

FIG. 7 is a diagram illustrating calculation of heights included in a BEV image 700 based on grid 728. BEV image 700 includes objects 730, including roadways 702, 704, curbs 706, 708, 710, 712, buildings 714, 716, 718, 720, 722 and trees 724, 726. The height of a grid 728 cell can be determined based on the maximum pixel height value included in the grid 728 cell. In other examples, an average pixel height value can be used as the height value. In either example, a single height value is used to determine the height value of the grid 728 cell.

The height values of each grid 728 cell can be compared to a user-determined threshold. The user-determined threshold can be determined based on a decision as to what object 730 height would cause interference with a vehicle 110. Interference can be defined as interaction between a grid 728 cell and a vehicle 110 that would cause damage to a vehicle 110, e.g. contact between the vehicle and an object with a height greater than the threshold. For example, a vehicle 110 can overlap a grid 728 cell that includes a curb 706, 708, 710, 712 without interference, while vehicle 110 overlapping a grid 728 cell that included a building 714, 716, 718, 720, 722 or trees 724, 726 would experience interference. Based on interference, a threshold of 10 centimeters is an example of a threshold that can be used to divide grid 728 cells that indicate interference from grid 728 cells that do not indicate interference. BEV image 700 has been divided into non-interfering cells 732 (no crosshatching) and interference cells 734 (crosshatching) based on grid 728 cell heights. Non-interfering cells 732 do not include objects 730 that exceed the threshold and interfering cells 734 include objects 730 that exceed the threshold.

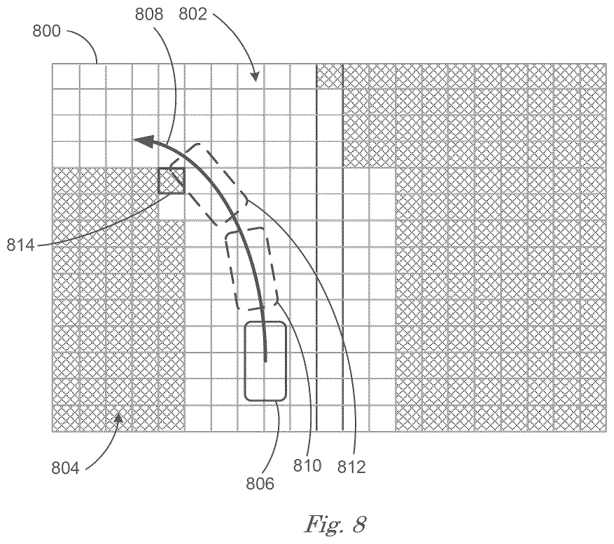

FIG. 8 is a diagram illustrating a grid 800 based on a BEV image 700 output from a machine learning model 500 that includes non-interfering cells 802 and interfering cells 804 as described above in relation to FIG. 7. Grid 800 including non-interfering cells 802 and interfering cells 804 can be combined with an object trajectory, in this example a vehicle trajectory 806 is determined based on sensor data to determine whether the fisheye images 302, 304, 306, 308 that were input to a machine learning model 500 to form BEV image 700 that was used to determine the grid 800 can be used to enhance the training of the machine learning model 500 using adaptive learning techniques as described herein.

As described above, fisheye images 302, 304, 306, 308 can be acquired from cameras 202, 204, 206, 208 included in vehicle 110. At the time the fisheye images 302, 304, 306, 308 are acquired, data regarding vehicle trajectory 808 and feature activation can be acquired from sensor data generated by sensors 116 included in vehicle 110. For example, GPS sensors, speedometers, wheel rotation sensors and accelerometers can acquire data regarding the location, orientation, and speed of vehicle 110 at the time the fisheye images 302, 304, 306, 308 are acquired to determine the location and orientation of vehicle outline 806 at a time to. Data acquired from controllers 112, 113, 114 and other vehicle components such as steering can be acquired by computing device 115 to determine if a feature activation has occurred.

The sensor can also acquire location, orientation, and speed data for time periods after the fisheye images 302, 304, 306, 308 are acquired to determine vehicle trajectory 808. The vehicle trajectory 808 can be used to determine the locations and orientations of vehicle outlines 810, 812 (dashed lines) at times t₁ and t₂, respectively, after time to. Inspection of grid 800 and vehicle trajectory 808 indicates that an interference event should have occurred between an interference cell 814 and vehicle outline 812 at time t₂. An interference event includes changes in a vehicle trajectory 808 in response to an interference or feature activation in response to an interference.

Vehicle sensor 116 data can also be used to determine whether vehicle 110 experienced an interference event at time t₂. If vehicle 110 experienced an interference event at time t₂, vehicle sensors 116 would register a change in speed or direction that indicate contact between the vehicle and an object with a height greater than the threshold. Likewise, a feature activation being detected by computing device 115 at time t₂ would indicate an interference event. If no change in vehicle trajectory 808 or no feature activation is detected at time t₂, an error is indicated in BEV image 700. An error in BEV image 700 can indicate that the machine learning model 500 has placed an object 730 in cell 814 erroneously. An erroneous object in cell 814 can indicate that the machine learning model 500 has responded erroneously to fisheye images 302, 304, 306, 308. This indicates that labeling fisheye images 302, 304, 306, 308 and training the machine learning model 500 using the labeled fisheye images 302, 304, 306, 308 can contribute to reducing the error rate of the machine learning model 500.

Techniques described herein for selecting data for labeling and training a machine learning model 500 based on verifying errors in machine learning model 500 output defines adaptive learning for a machine learning model 500. By selecting data that will likely reduce erroneous output when used to train a machine learning model 500 computing resources used to label and train a machine learning model 500 are minimized while enhancing the accuracy of results.

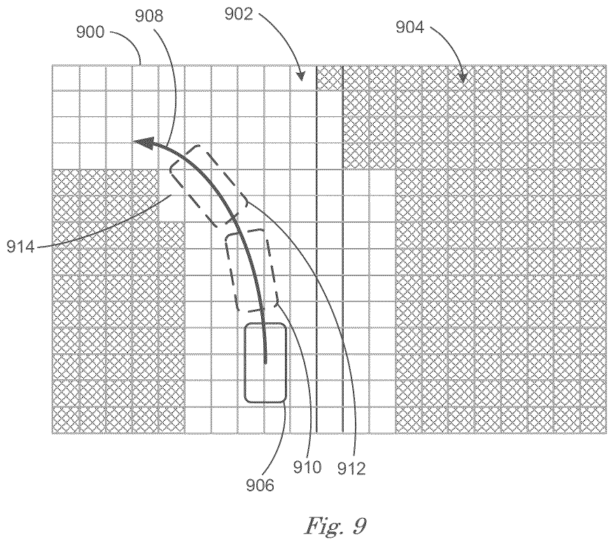

FIG. 9 is a diagram of grid 900 based on a BEV image 700 output from a machine learning model 500 that includes non-interfering cells 902 and interfering cells 904 as described above in relation to FIG. 7. Grid 900 was generated following labeling and training of machine learning system 500 based on the interference detected in FIG. 8. Grid 900 illustrates cell 914 being correctly indicated as non-interfering, which is correctly correlated with vehicle trajectory 908 which indicates vehicle 110 traveling from location indicated by outline 906 at time t₀ to locations indicated by outlines 910, 912 at times t₁ and t₂, respectively.

If vehicle sensors 116 have registered a change in speed or direction that indicates an interference event between the vehicle and an object with a height greater than the threshold and an interference event is indicated. Likewise, a feature activation being detected by computing device 115 at time t₂ could indicate an interference event. If a change in vehicle trajectory 908 or a feature activation is detected at time t₂ and no interference is indicated by grid 900, an error is indicated in BEV image 700. An error in BEV image 700 can indicate that the machine learning model 500 has not placed an object 730 in cell 914 erroneously. An erroneous object in cell 914 can indicate that the machine learning model 500 has responded erroneously to fisheye images 302, 304, 306, 308. This indicates that labeling fisheye images 302, 304, 306, 308 and training the machine learning model 500 using the labeled fisheye images 302, 304, 306, 308 can contribute to reducing the error rate of the machine learning model 500.

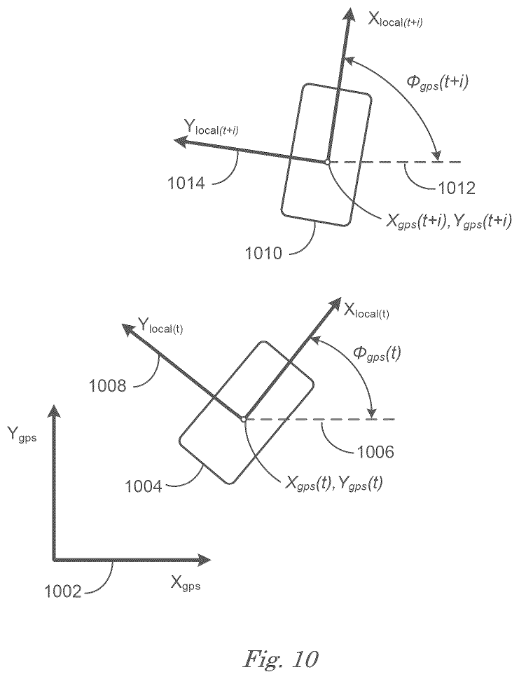

FIG. 10 is a diagram of vehicle outlines 1004, 1008 illustrating vehicle pose calculations. To correctly place vehicle outlines 1004, 1008 on a grid 900, vehicle trajectory 908 data is applied to vehicle outlines 1004, 1008. FIG. 10 includes a frame of reference 1002 that describes locations and orientations in global coordinates X_{gps}, Y_{gps}. Vehicle trajectory 908 data including vehicle locations and orientations is received from a vehicle 110 in global coordinates:

$${X}_{gps ( t + i )} , {Y}_{gps ( t + i )} , {Φ}_{gps ( t + i )} , i = 0 , 1 , 2 … , {t}_{p} \qquad ( 1 )$$

Where X_{gps(t+i)} is the vehicle location in a direction parallel to longitude from vehicle GPS sensors at time t+i, Y_{gps(t+i)} is the vehicle location in a direction parallel to latitude from vehicle GPS sensors at time t+i, and Φ_{gps(t+i)} is the vehicle orientation with respect to frame of reference 1002 at time t+i.

Determination of grid interference can be performed by translating vehicle outlines from global coordinates to local coordinates X_{local(t+i)}, Y_{local(t+i)}. Local frames of reference 1008, 1014 are rotated with respect to local translations 1006, 1012 (dashed lines) of global frame of reference 1002 by global orientations gps(t) and gps(t+i), respectively. Local locations X_{local(t+i)}, Y_{local(t+i)} can be determined by the equation:

$$[ \begin{matrix}{x}_{local ( t + i )} \\ {y}_{local ( t + i )}\end{matrix} ] = [ \begin{matrix}cos ( ϕ ( t + 1 ) ) & sin ( ϕ ( t + 1 ) ) \\ - sin ( ϕ ( t + 1 ) ) & cos ( ϕ ( t + 1 ) )\end{matrix} ] [ \begin{matrix}{x}_{local ( t + i )} - {x}_{local ( t )} \\ {y}_{local ( t + i )} - {y}_{local ( t )}\end{matrix} ] \qquad ( 2 )$$

For i=0, 1, 2, . . . , tₚ.

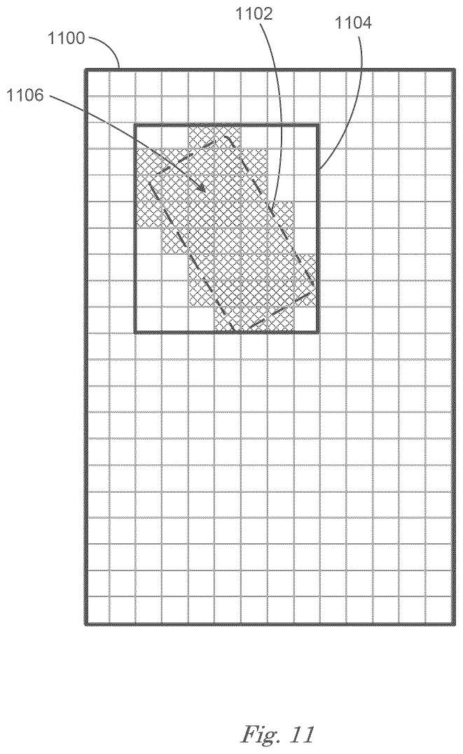

FIG. 11 is a diagram of grid 1100 that illustrates determination of cells occupied by a vehicle outline 1102 translated and oriented as described in FIGS. 8-10. Vehicle outline 1102 is enclosed by a bounding box 1104, where the bounding box 1104 is determined by the minimum x and y grid elements that completely enclosed the vehicle outline 1102. Any grid 1100 cells that occur within the bounding box 1104 that are within or contact the vehicle outline 1102 are included as occupied cells 1106 (crosshatching) for the vehicle outline 1102.

Occupied cells 1106 can be determined by constructing a polytope that connects the sides of the vehicle outline 1102 with each of the cells within the bounding box 1104. A polytope is a generalization of a polyhedron for n dimensions. In this example, the polytope is a four-sided pyramid with vehicle outline 1102 as the base and each cell of bounding box 1104 cell as the peak, taken in turn. If the any portion of the peak of the polytope falls within vehicle outline 1102, the cell that formed the peak is included as an occupied cell 1106. With regard to FIG. 8, any occupied cell 1106 included in vehicle outline 1102 that overlaps an interference cell 804 will generate an interference event.

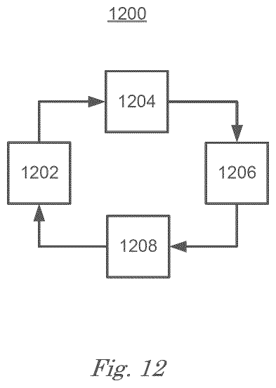

FIG. 12 is a diagram of an adaptive learning system 1200. Adaptive learning system includes data and software programs executing on a server computer 120 under the control of a software program that controls the flow of data and results between software programs included in the adaptive learning system 1200. Adaptive learning system 1200 includes a machine learning model 1204 trained with a first training dataset to receive fisheye images 302, 304, 306, 308 from training dataset 1202 that include images of an environment around a vehicle and output a BEV image 600.

The output BEV image 600 is received by an interference engine 1206 which determines an interference grid 800 based on the received BEV image 600 and occupied cells 1106 based on vehicle sensor 116 data determined by vehicle 110 at the time the fisheye images 302, 304, 306, 308 were acquired. Interference engine 1206 can determine interference between objects 630 included in a BEV image 600 and a vehicle outline 812 is determined as described in relation to FIGS. 8, 9, 10 and 11. In examples where interference engine 1206 determines that an interference between objects 630 included in a BEV image 600 exists, the input fisheye images 302, 304, 306, 308 and the location of the interference in the BEV image 600 can be passed to labeling machine learning model 1208.

Labeling machine learning model 1208 receives the labeled BEV image 600 along with the data from the interference engine 1206 that indicates the location or locations that were incorrectly labeled and corrects the labels on the BEV image 600. The re-labeling can be done on the BEV image 600 by a machine learning model trained to correctly label BEV image 600. In some examples, the labeling can be performed off-line by humans. In either machine learning model labeling or human labeling, the portion of the BEV image 600 that caused the incorrect interference, or non-interference, is noted to ensure that the portion that caused the error is properly labeled.

Following labeling machine learning model 1208 the BEV image 600 including the ground truth labels, the input fisheye images 302, 304, 306, 308 and the included vehicle data are returned to training dataset 1202 for training machine learning model 1204 as described above in relation to FIG. 5. In examples of adaptive machine learning training, multiple sets of fisheye images 302, 304, 306, 308 including ground truth can be combined into a second training dataset for training the machine learning model. Training machine learning model 1208 based on determining errors in output data using an independent source of data such as vehicle trajectories can enhance training of machine learning models by determining datasets that will provide enhancements in performance while minimizing computing resources devoted to labeling and training by selecting data that generates erroneous results.

Following training of the machine learning model 1204, the machine learning model 1204 can be transmitted from the server computer 120 via a network 130 to a computing device 115 included in a vehicle 110. The machine learning model can be executed on computing device 115 to receive image data from sensors 116 included in vehicle 110 and output BEV images 600 to be used by computing device 115 to operate vehicle 110.

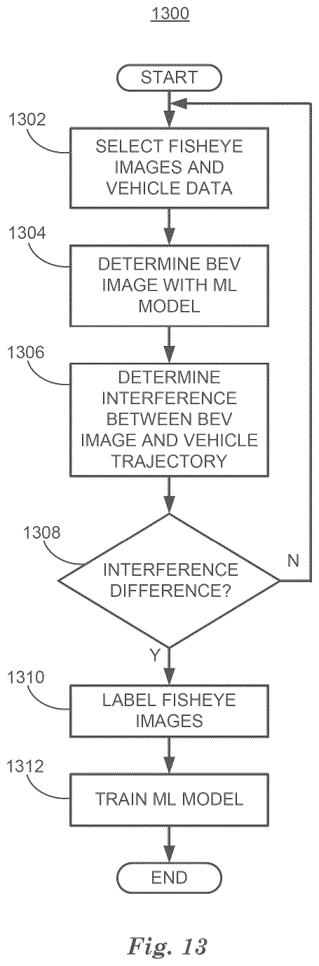

FIG. 13 flowchart diagram of a process 1300 for adaptive training of a machine learning model 1204. Process 1300 can be implemented as hardware and software executing on a server computer 120 to train the machine learning model 1204. Process 1300 includes multiple blocks that can be executed in the illustrated order. Process 1300 could alternatively or additionally include fewer blocks and can include the blocks executed in different orders.

At block 1302 a first software program executing on server computer 120 selects unlabeled fisheye images 302, 304, 306, 308 from a training dataset 1202 of fisheye images acquired from vehicle 110. The fisheye images 302, 304, 306, 308 include vehicle acquired from vehicle sensors 116 that indicate multiple vehicle locations and orientations at multiple time steps. For example, the time steps can indicate multiple sets of fisheye images 302, 304, 306, 308 acquired at multiple video frame times. The fisheye images 302, 304, 306, 308 include vehicle location and pose data that can be used to determine a vehicle trajectory 808 and vehicle feature activation data as described above.

At block 1304 a machine learning model 1204 trained on a first labeled dataset inputs fisheye images 302, 304, 306, 308 and outputs a BEV image 600 as described above in relation to FIG. 4.

At block 1306 interference engine 1206 applies grid 628 to a BEV image 600 and determines non-interference cells 732 and interference cells 734 based on object heights exceeding a threshold. The vehicle location and orientation data included in fisheye images 302, 304, 306, 308 is used to determine multiple vehicle outlines 1102 as described above in relation to FIGS. 10 and 11. Vehicle outlines 1102 and feature activation data are combined with the non-interference cells 732 and interference cells 734 to determine if the combination of vehicle outlines 1102, feature activation data, and BEV image 600 indicates an interference events when none occurred in vehicle data or indicates no interference when an interference event did occur in vehicle data.

At block 1308, when no difference exists between the BEV image 600 and the vehicle data as to the occurrence or non-occurrence of an interference event, process 1300 loops back to block 1302 to select another set of fisheye images 302, 304, 306, 308 and corresponding vehicle trajectory and feature activation data. When a difference exists between the BEV image 600 and the vehicle data as to the occurrence or non-occurrence of an interference event, process 1300 passes to block 1310.

At block 1310 BEV image 600 are passed to labeling machine learning model 1208 for ground truth labeling with identities and locations of objects including corrections determined by interference engine 1206 as described above in relation to FIG. 12. The BEV image 600 and the ground truth identities and locations of objects are passed to training dataset 1202.

At block 1312 the BEV image 600, the ground truth labels, the vehicle data and the original fisheye images 302, 304, 306, 308 are output by training dataset 1202 to machine learning model 1204 for training. The machine learning model is trained to output a new BEV image 600 that includes correct identification and location of objects included in the new BEV image 600 as described above in relation to FIG. 5. Following block 1312 process 1300 ends.

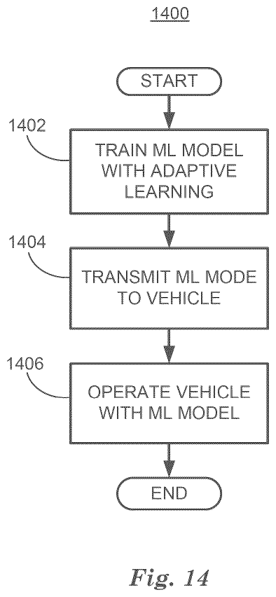

FIG. 14 flowchart diagram of a process 1400 for operating a vehicle 110 based on adaptive training of a machine learning model 1204. Process 1400 can be implemented as hardware and software included in a server computer 120 to train the machine learning model 1204 and hardware and software included in a computing device 115 included in a vehicle 110. Process 1400 includes multiple blocks that can be executed in the illustrated order. Process 1400 could alternatively or additionally include fewer blocks and can include the blocks executed in different orders.

Process 1400 begins at block 1402, where a machine learning model 1204 is trained on a server computer 120 based on adaptive learning as described above in relation to FIGS. 12 and 13, above.

At block 1404 the trained machine learning model 1204 is transmitted to a computing device 115 included in a vehicle 110.

At block 1406 computing device 115 acquires fisheye image 302, 304, 306, 308 from sensors 116 included in vehicle 110. Machine learning model 1204 receives the fisheye images 302, 304, 306, 308 and outputs a BEV image 600. The BEV image 600 can be received by a second machine learning model included in computing device 115 to determine objects 630 including roadways 602, 604, curbs 606, 608, 610, 612, buildings 614, 616, 618, 620, 622, trees 624, 626 and other objects such as vehicles, traffic signs, traffic barriers, etc. Computing device 115 can determine a vehicle trajectory based on the objects 630 included in BEV image 600. Computing device 115 can control vehicle 110 to operate on vehicle trajectory by transmitting commands to vehicle controllers 112, 113, 114 to control vehicle components. Following block 1406 process 1400 ends.

Any action taken by a vehicle or user of the vehicle should comply with all rules and regulations specific to the location and operation of the vehicle (e.g., Federal, state, country, city, etc.). More so, any operations disclosed herein are for illustrative purposes only. Certain operations may be modified and omitted depending on the context, situation, and applicable rules and regulations. Further, regardless of the operations or determinations, users should use good judgement and common sense when operating the vehicle. That is, all operations, whether standard or “enhanced,” should be followed only when proper to do so and when in compliance with any rules and regulations specific to the location and operation of the vehicle.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to:
determine a depth map based on an image received by a machine learning model trained on a first training dataset;
determine an object trajectory for an object included in the image;
select the image based on determining an interference between the object and the depth map based on the object trajectory;
determine a second training dataset by adding the selected image to the first training dataset; and
train the machine learning model with the second training dataset.

2. The system of claim 1, wherein the machine learning model determines locations of three-dimensional features in the depth map of an environment around the object.

3. The system of claim 2, wherein the depth map is formatted as cells laid out on a grid, wherein one or more of the cells are occupied cells that are occupied by one or more of the three-dimensional features with a height that exceeds a user-determined threshold with respect to a ground plane.

4. The system of claim 3, wherein the interference is determined by an overlap between the object and the one or more occupied cells at a location predicted based on the trajectory.

5. The system of claim 1, wherein the object trajectory is determined based on sensor data from sensors included in the object.

6. The system of claim 1, wherein adding the selected images to the first training dataset includes determining a label for the object.

7. The system of claim 6, wherein a second machine learning model determines the label for the object.

8. The system of claim 1, wherein the machine learning model is a generative adversarial network that includes an encoder, a decoder, and a discriminator.

9. The system of claim 1, wherein the depth map includes portions of one or more of a roadway, a curb, a building, and a tree.

10. The system of claim 1, wherein the object is a vehicle.

11. The system of claim 1, further comprising a second computer, wherein the machine learning model after training is included in the second computer in a second vehicle, wherein the second computer is programmed to operate the second vehicle by determining a vehicle trajectory based on output from the machine learning model.

12. The system of claim 11, wherein the second computer is programmed to operate the second vehicle on the vehicle trajectory by commanding controllers to operate vehicle components.

13. A method, comprising:
determining a depth map based on an image received by a machine learning model trained on a first training dataset;
determining an object trajectory for an object included in the image;
selecting the image based on determining an interference between the object and the depth map based on the object trajectory;
determining a second training dataset by adding the selected image to the first training dataset; and
training the machine learning model with the second training dataset.

14. The method of claim 13, wherein the machine learning model determines locations of three-dimensional features in the depth map of an environment around the object.

15. The method of claim 14, wherein the depth map is formatted as cells laid out on a grid, wherein one or more of the cells are occupied cells, that are occupied by one or more of the three-dimensional features with a height that exceeds a user-determined threshold with respect to a ground plane.

16. The method of claim 15, wherein the interference is determined by an overlap between the object and the one or more occupied cells at a location predicted based on the object trajectory.

17. The method of claim 13, wherein the object trajectory is determined based on sensor data from sensors included in the object.

18. The method of claim 13, wherein adding the selected images to the first training dataset includes determining a label for the object.

19. The method of claim 18, wherein a second machine learning model determines the label for the object.

20. The method of claim 13, wherein the machine learning model is a generative adversarial network that includes an encoder, a decoder, and a discriminator.
